(19) United States
(12) Patent Application Publication
(10) Pub. No.: US 2002/0103275 A1
(43) Pub. Date: Aug. 1, 2002

(54) Composition for use in manufacturing stoppers and method of making same

(76) Inventor: Joao Augusto dos Santos Nogueria de Sousa, Santa Maria de Lamas (PT)

Correspondence Address: Spohn & Robertson LLP, P.O. Box 5748, Napa, CA, 94581-0748, US

(21) Appl. No.: 09/773,448

(22) Filed: Jan. 31, 2001

(51) Int. Cl. C08L 1/00

(52) U.S. Cl. 524/16

(57) ABSTRACT

A composition and process of manufacture for a stopper for use in bottling still wines comprised of ligneous plant matter—preferably natural cork granules, a light thermoplastic resin and two hydrocarbon blowing agents either alone or in combination, such that when a reasonable amount of heat is applied, a product of suitable compressibility and impermeability to gases is produced.

### FIELD OF THE INVENTION

The present invention relates to a combination of man made material and natural cork or ligneous plant matter to be used in particular as a stopper for a bottle containing wine or other liquids. The technical domain of the inventions is that of the cork industry.

### BACKGROUND OF THE INVENTION

Much research has progressed in the field of natural cork, artificial cork, and combinations thereof for the purpose of attaining economical and efficient stoppers for wine and spirit bottles among other similar uses.

Currently, the demand for natural corks is far outweighed by the economies to be gained from artificially produced stoppers. Natural cork from cork oaks is only harvested in a few regions of the world, and it takes an inordinate amount of time for a cork oak's bark to be suitable for harvest, let alone for the cork oak to rejuvenate its bark.

When speaking of the variations of corks in production, they may be categorized as 1) natural corks—those corks which are of one single piece of cork material; 2) agglomerated corks those corks comprised of bits of natural cork with a suitable binding agent; 3) composite corks those corks comprising plastics in some combination with natural cork; and 4) synthetic corks, typically comprised solely of plastics and like materials.

A great deal of interest has been focused on the use of an agglomerated cork; i.e., a cork which has been fashioned from natural particles of cork and held together by a binding agent. Such binding agents are primarily comprised of glues, paraffin and paraffin oils. While not as efficient as high quality natural corks in their tightness and interaction with wine, agglomerated corks allow the use of small pieces of cork and their natural characteristics without being dependent on large pieces of natural cork for their production. Agglomerated corks are therefore far cheaper than most grades of natural cork.

Natural cork, while having many distinct advantages for use as a stopper, has its share of disadvantages. For example, depending on the inherent quality of the cork itself, defects in the form of large cavities which adversely affect the tightness of the individual stopper may be visible to the observer. In addition, during the processing phase of natural cork stoppers, cork powder may be used to fill such holes, and may later disintegrate, affecting the tightness of the stopper, or even becoming entrained in the contained liquid itself Such corks are of lesser quality, and therefore, lesser cost, and are termed Colmated corks by the industry. The present invention is intended to compete with such corks on a price comparison basis: however, yielding superior functional quality without the propensity for introducing powder or cork pieces into the bottled liquid.

There are currently at least six grades of natural cork stoppers, with a wide range of cost across the grading spectrum. Unfortunately, at the low end of the quality spectrum, some natural cork may be prone to adversely affect the taste of wine with which it has been in contact.

As the field of this invention has progressed, composite corks made primarily of polyurethane or similar plastics have been developed. Such stoppers are quite efficient in providing a high level of tightness, but are not as desired for wines intended to age in the bottle. For such applications, natural cork is more desirable. However, due to the economic pressures on wine producers, and the often reduced expected shelf life of certain of their products, synthetic corks are becoming widely used for wine bottling.

For an example of the kinds of plastics used in manufacturing artificial stoppers, one may review the Canadian Patent Application 1 17 600 (Paisley, et al.) which describes and claims a method of manufacturing stoppers of plastics material by molding (particularly ethylene-vinyl acetate copolymer).

U.S. Pat. No. 4,042,543, granted to Strickman et al. describes a composition whereby the plastics are mixed with natural cork, and fused at high temperature. Lately, the Sabate patent, U.S. Pat. No. 5,317,047, has further developed a composition for a composite cork using a range of binding agents and closed cell foam material.

A drawback to composite corks is that the end product does not have the appearance of natural cork. While some premium wineries around the world have been experimenting with composite corks and lately even screw-top stoppers (see the recent announcement to the wine industry by Plumpjack Winery in Napa, Calif. for their premium wine utilizing a screw top and costing $115.00 per bottle) it is still the usual practice to utilize high quality natural corks for the highest priced wines. Consequently, there is much resistance to using a composite cork with a very expensive bottle of wine.

Because of the above considerations, makers of composite corks use coloring agents and binding agents of various colors to attempt to make the composite cork look natural. Artistically applying different names and art to composite corks tends to also make the composite corks look like natural corks which have been burnt with, for example, the winery's name or trademark.

Agglomerated corks do not require the same color considerations as composite corks, because they are comprised in substantial part, of natural cork pieces. The visual impact of agglomerated corks is different, in that instead of a lack of appropriate color, the agglomerated cork evidences the bound particle nature of the cork, and does not give the appearance of uniform natural cork.

One example of the use of agglomerated corks is in the champagne and sparkling wine application. Because the typical natural cork for use with champagne is roughly over three times the size of that used for still wines, there has been greater economic incentive to find use agglomerated cork. The most successful use of agglomerated cork in conjunction with sparkling wines has been a cork fashioned of a combination of agglomerated material which is then bonded to a piece of natural cork. The natural cork is that portion of the stopper which comes in contact with the sparkling wine, and the agglomerated portion is that which protrudes from the neck of the bottle and is enclosed in the cage and foil wrapper as is the usual case.

If the same type of cork were used in a bottle containing still wine, some differences would become immediately apparent. First, when the foil is removed from the bottle, it would be evident that agglomerated cork was being used as a stopper. Second, unlike champagne or sparkling wine bottles, a corkscrew of some kind is typically used to uncork the wine.

When natural cork is cut into pieces for utilization as a wine bottle stopper, certain considerations apply in how the cork is “punched” from the unrolled bark. It is worth examining how the typical natural cork is processed.

The incredible properties of natural cork are primarily the result of cork's unique structure. The bark of the cork tree is composed of tiny cells, each a 14-sided polyhedron, with the intercell space entirely filled with air. There are approximately 40 million of these cells in a single cubic centimeter of cork bark. Cork trees are harvested in the summer, every nine or ten years, after they reach 25 centimeters in diameter. Harvesting a cork oak requires very skilled labor. A special axe is used to cut into the bark and then used as a lever to gently pry the cork off the tree.

The cork is peeled off in large panels from the main sections of the trunk, including the large branches. About a third of the bark can be harvested from the tree at one time. Great care is taken to avoid cutting into the cambium layer of the living tree. After the harvest, the trees will be left alone to re-grow their bark, which takes about 9 years. There is a significant difference between the first harvest, or virgin harvest, and the third harvest. The virgin cork is rough, crumbly, and can only be used for cork board, insulation, gaskets, shoe soles, etc. By the third harvest, the cork is a smooth, clear bark that will make great wine corks. After the cork is harvested, it is carefully stacked in the forest so that rainfall will gently wash through it. The cork is left to age for a period of months in the forest to allow the moisture content to stabilize. Then, after aging, the cork is boiled to provide a relatively soft, flexible material suitable for manufacture into a stopper.

Following the corkwood sorting process, it is sliced into narrow strips as wide as a wine cork is long, from which the corks will be punched. Each shows the growth rings of the tree running vertically through it. The punching is very technical work. While lower grade corks can be punched by automated machines, premium corks require punching by skilled craftsmen. They ensure that imperfections in the corkwood do not turn up in the final cork.

As state previously, after preparation and grading, the bark pieces are punched. The thickness of the cork piece is such that the cork must be punched laterally in order to achieve a full length cork. Further, vertical punchings contain one primary deficiency; the cork has more inherent porosity due to the existence of vertical lenticels in the vertical punching. The existence of this porosity makes the cork less suitable for use as a premium wine cork because the desired tightness would not be possible. Therefore, suitable cork material of insufficient thickness for a standard length wine cork may still be used to create a disc such as that employed in the champagne and sparkling wine stoppers previously described.

At present, there but a few composite corks which can satisfy the need for a cork which provides an appropriate seal, sufficiently contacts the wine, gives the proper appearance when inserted into a wine bottle, and allows for the smooth uncorking of the bottle satisfactorily equal to that of a natural cork.

Part of the challenge in creating a composite cork is based on the availability of suitable polyurethane or other closed cell materials. In the Sabate patent mentioned above, a plastics material with closed cellular structure is used whose cells present a mean internal dimension on the order of 10 to 20 microns. The preferred microspheres are identified as a copolymer of methyl metbacrylate and of acrylonitrile containing at optimum, at least one part of methyl methacrylate for five parts of acrylonitrile.

These microspheres are substantially tight, and contain a hydrocarbon such as iso-Butane. They are taken from the following group-polymer or copolymer of vinyl chloride, a polymer or copolymer of vinylidene chloride, a polymer or copolymer of vinyl chloride and acrylonitrile, a polymer or copolymer of vinylidene chloride, acrylonitrile and methyl methacrylate and/or a polymer or copolymer of styrene and acrylonitrile, a polymer or copolymer of ethylene or vinyl acetate; and lastly and preferably a copolymer of methyl methacrylate and acrylonitrile.

Also set forth in Sabate, are preferences for the rest of the constituents of the composite cork. In addition to the microspheres of small dimension, the remaining constituents comprise large microspheres whose mean dimension is less than 5 millimeters; ligneous plant material, principally natural cork, and some binding agent such as a food quality glue. Of course, outside of these basic constituents, it is recognized that additives such as coupling agents, stabilizers, pigments or colorants, lubricants and water may be utilized.

Further additions may include a latex in the form of a polyisoprene emulsion for further modifying and improving cohesion of the final product; waxes or paraffins for reducing the coefficient of friction of the products, and to facilitate removal of the product from the manufacturing process.

The prior art as espoused in Sabate calls for the manufacture of such composite corks by mixing the ligneous matter with the microspheres, addition of a binding agent in order to obtain a homogeneous pulverulent product, placing the product into a mold or die, and then rapidly heating the product between 90° C. and 200° C., preferably between 100° C. and 150° C. The product is then maintained at a temperature of between 50° C. and 120° C., preferably between 70° C. and 1000° C.

The end product may then be used as an “active” part of a stopper (for example, the active part of a champagne stopper is that part of the cork engaged in the neck of the bottle—that part of the stopper above the neck is therefore, the inactive part). Therefore, it is the quality of the “active” part of the stopper then, that concerns those interested in employing composite corks.

It is desirable to have an active part of the stopper which is elastic and tight to liquids while maintaining a low permeability to gases.

In the Sabate composition, the expansion of the microspheres yields a mean dimension of approximately 40 to 100 microns, and the proportion by mass of particles of ligneous plant matter is between 1% and 85%, and preferably between 15% and 75The proportion by mass of microspheres in the active part of the stopper is between 1% and 60%, preferably between 2% and 25%. The proportion by mass of the binding agent in the active part of the stopper is between 5% and 70%, and preferably between 15% and 60%. The proportion by mass of water in the active part of the stopper is less that 15% and preferably less than 10%. The result of all this is a product with a proportion of void or hollow spaces filled with air or fluid grater than 50% which makes the product easily compressible in order to insert the stopper into a bottle.

While the Sabate stopper works satisfactorily, and may be suitably employed in the wine bottling process, some drawbacks remain. First, with the blowing agent of iso-Butane and the microspheres taken from the group of polymers and copolymers identified, it is necessary to introduce sufficient energy in the form of heat to expand the microspheres and thereby form the stopper. What is needed is a process which can produce a stopper at a substantially lower temperature or without energy expenditures necessary to “cure” the composition.

Also, if one were able to use a higher proportion of ligneous plant matter and less of a binding agent, it is conceivable that less other additives would be required, such as coloring agents and stabilizers. What is needed is a composite cork of composition allowing flexibility in the ratios of ligneous plant matter or cork to binding agent.

### SUMMARY OF THE INVENTION

It is an object of the present invention to provide a composite cork comprised of a combination of natural cork or ligneous plant matter and a thermoplastic resin which is suitable for use as stoppers for wine bottles and is competitively priced.

It is also an object of the present invention to provide a composite cork in combination with natural cork particles which provides a suitably high quality contact with wine.

It is a further object of the present invention to provide a composite cork of thermoplastic resin and natural cork such that the cork may be removed from the wine bottle with ease similar to natural cork.

It is a further object of the present invention to be able to utilize a resin and blowing agent combination which allows formation of the composite cork at reduced temperatures.

It is a further object of the present invention to produce a composite cork with very light thermoplastic resins combined to give the appearance of a premium natural wine cork.

It is yet another object of the present invention to produce a composite cork of composition allowing flexibility in the ratios of ligneous plant matter or cork to binding agent.

The preferred embodiment of the present invention comprises a combination of cork particles and a light thermoplastic resin in conjunction with up to two blowing agents (alone or in combination), such that when expanded at substantially less than 100° C., a suitable wine bottle stopper is produced.

### DETAILED DESCRIPTION OF THE PREFERRED EMBODIMENT

Applicant has conducted much research into the various closed cell microspheres used in the manufacture of composite “corks.” Through this research, Applicant has discovered a copolymer having one or more blowing agents, which, when mixed with appropriate amounts of ligneous plant matter and a binding agent, produces a wine stopper of good compressibility and impermeability to gases at a lower temperature than typically required in the prior art.

The ligneous plant material, preferably cork granules, used by applicant in the present invention include particles of of a mean diameter of less than 2 millimeters. Preferably, a larger percentage of the granules, or about 80% have a mean diameter of between 0.5 and 1.0 millimeter. The balance, or approximately 20%, have a mean diameter of approximately 1 to 2 millimeters.

Applicant has determined that the copolymer vinylidene chloride and acrylonitrile, in conjunction with a blowing agent of either iso-Butane or n-Pentane (alone or in combination), and having a mean dimension size range of 6-10 microns and a suitable binding agent will yield a suitable stopper when expansion is achieved at a temperature of only 80° C. to 85° C. With the lower temperature, the mean dimension of the expanded microspheres is between 25 to 35 microns.

The copolymer vinylidene chloride and acrylonitrile is extremely light, and yet has all the characteristics necessary to achieve a composition well suited for a wine bottle stopper.

The distinct advantage heretofore unachieved is the availability of a copolymer which, with either of two blowing agents taking singly or in combination, will expand and interact suitably with the ligneous plant matter and a binding agent at a substantially lower temperature than currently known in the prior art. The difference between heating a mixture to at least 100° C. and perhaps from 100° C. and 150° C. (holding a curing temperature between 70° C. and 100° C.), and only heating a mixture to between 80° C. to 85° C. without any hold or “curing” time at elevated temperature is significant. The ability to lower manufacturing costs due to reduced energy consumption is a distinct advantage, and is part and parcel of the novelty of applicant's invention.

Applicant has further demonstrated that proportions of ligneous plant matter or cork granules in excess of 85% may be employed in the present invention, with less than 10% binding agent, and only 4% to 6% of thermoplastic resin.

For manufacturing stoppers from the composition and by the process according to applicant's preferred embodiment of the invention, the following proportions of the constituents of said composition may be used.

Expanded or expansible microspheres: 1 to 60%;

Cork powder and granules 1 to 87%;

Polyurethane or acrylic glue: 9 to 70%;

Latex emulsion: less than 10%;

Water: less than 12%;

Wax or paraffin: less than 5%;

Catalyst: less than 1%.

The percentages set forth herein above are expressed in terms of proportion by mass of the constituents with respect to the total mass of the mixture, i.e., the total mass of the composition employed in the manufacture of the stoppers or active parts of said stopper. In the particular case of using the composition for manufacturing stoppers, the following proportions give extremely successful results:

Expansible microspheres of copolymer of vinylidene chloride and acrylonitrile: between 4% and 6%;

Cork powder and/or granules between 40 and 50%;

Polyurethane glue: between 30% and 40%;

Latex and wax or water and catalyst: less than 15%.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

I claim:

1. A composition useful for manufacture of products with an appearance of natural cork comprising:
a. 1%-87% of particles of ligneous plant matter;
b. 1%-60% of a plastics material of closed cellular structure having microspheres; said microspheres having a means dimension of less than 50 microns, said microspheres containing at least one hydrocarbon expansion agent;
c. 5%-70% of a binding agent.

2. The composition according to claim 1, wherein the ligneous material is natural cork.

3. The composition according to claim 1, wherein said hydrocarbon is selected from the group consisting of iso-Butane and n-Pentane.

4. The composition according to claim 1, wherein the particles of the ligneous material having a means dimension of between 0.5 millimeter and 2 millimeters.

5. The composition according to claim 1, wherein said plastics material is a copolymer of vinylidene chloride and acrylonitrile.

6. A stopper comprising a composition according to claim 1.

7. A stopper comprising a composition according to claim 1, wherein said composition has a proportion of void or hollow spaces filled with air or fluid where the proportion of void or hollow spaces is greater than 50%.

8. A process for making a composition according to claim 1 comprising:
a. mixing particles of ligneous plant matter with a plastics material of closed cellular structure;
b. adding to said mixture, a binding agent to obtain a homogeneous pulverulent product;
C. introducing said homogeneous pulverulent product into a shaping device;
d. rapidly heating said product introduced in said shaping device, up to a temperature of 85° C. to expand said cells;
e. removing the product from the shaping device, maintaining said product at room temperature.

9. A stopper comprising:
a. 1%-87% of particles of natural cork;
b. 4%-60% of a plastics material of closed cellular structure having microspheres of a mean dimension of less than 50 microns wherein said microspheres contain at least one hydrocarbon expansion agent;
c. 9%-70% of a glue selected from polyurethane or an acrylic.

10. The stopper according to claim 6, wherein the mean dimension of the microspheres is between 10-50 microns.

11. The stopper according to claim 6, wherein said plastics material is a copolymer of vinylidene chloride and acrylonitrile.

12. The stopper according to claim 6, further comprising a latex emulsion and pigments.

13. The stopper according to claim 6, wherein the mean dimension of said microspheres is between 25 and 35 microns.

14. The Stopper according to claim 6, wherein said hydrocarbons are iso-Butane or n-Pentane.

15. The stopper according to claim 6, where the microspheres of the plastics material are a copolymer of vinylidene chloride and acrylonitrile, said microspheres have a mean dimension of between 25 and 35 microns and said hydrocarbon is either iso-Butane, or n-Pentane or both.
